(19) United States
(12) Patent Application Publication
(10) Pub. No.: US 2007/0079098 A1
(43) Pub. Date: Apr. 5, 2007

(54) Automatic allocation of volumes in storage area networks

(75) Inventor: Manabu Kitamura, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/243,069

(22) Filed: Oct. 3, 2005

(51) Int. Cl. G06F 12/00

(52) U.S. Cl. 711/170; 711/203

(57) ABSTRACT

A storage system including a storage controller is coupled to a host computer. When the host computer is connected, the controller deploys a set of virtual devices dedicated to the host computer, which typically cannot be accessed by other host computers. The storage controller includes a logical device manager that defines a group of logical devices from among disk drives in the storage system, and each logical device is assigned a storage area that includes at least a portion from a disk drive. A virtual device manager defines virtual devices from the group of logical devices, and maintains a record of the relationships among the logical devices and the virtual devices. When a request for a data operation is received by the storage system from a host which has not previously accessed the storage system, the virtual device manager defines a virtual device for access by that host and assigns a logical device to the virtual device.

### BACKGROUND OF THE INVENTION

This invention relates to techniques for automatically allocating logical devices to host computers in storage area networks.

Organizations throughout the world now are involved in data transactions which include enormous amounts of text, video, graphical, and audio information. This information is being categorized, stored, accessed, and transferred every day. The volume of such information continues to grow rapidly. One technique for managing such massive amounts of information is to use storage systems. Storage systems include large numbers of hard disk drives operating under various control mechanisms to record, back up, and enable reproduction of this enormous amount of data. This rapidly growing amount of data requires most organizations to manage the data carefully with their information technology systems.

A storage area network (commonly known as a SAN) is typically constructed using an interconnection means to connect host computers and storage devices to each other. Typical interconnections are provided using Ethernet or Fibre Channel. Such an approach enables all storage devices to be accessed from all host computers, sometimes causing high levels of complexity of storage management. Typically when a user provides a storage device, whether characterized as a physical storage device or a logical storage device, to a storage system coupled to a host computer, various configuration operations are required. For example, the user or service technician typically needs to configure the storage network, using Fibre Channel switches or Internet protocol switches and routers, so that the storage devices which are to be accessed by that host computer cannot be accessed from other host computers. If the storage configuration is huge, this configuration operation can be complex. If the storage devices that are assigned to host computers are logical storage devices, then the service technician or user first must configure the logical storage device, typically using a management console in the storage system. Such configuration operations are also complicated. At least one reference, U.S. Pat. No. 6,779,083 describes a method for allowing access to logical units or logical devices from a specified group of host computers. The access information enabling particular host computers to access particular logical units is then provided by users of the system. This is obviously a time consuming, complex task, and is prone to error.

What is needed is an improved technique for configuring storage systems and storage area networks to make such configuration operations easier.

### BRIEF SUMMARY OF THE INVENTION

In one embodiment, a system according to this invention includes a plurality of host computers and at least one storage system. Each host is connected to the storage system using a storage area network, typically Fibre Channel or Ethernet. Whenever a host computer is connected to the storage area network, the storage system deploys a set of virtual devices that are dedicated to the host computer and cannot be accessed by other host computers.

In another embodiment, the system includes a plurality of host computers and a plurality of storage devices and at least one storage area network controller. Each host and each storage device, and the controller are interconnected in a storage area network with each other. When a host computer is connected to the storage area network, the controller deploys a set of virtual devices dedicated to the host computer, which cannot be accessed by other host computers. In addition, when host computers are connected to the storage area network, the logical devices are automatically created and each such device cannot be accessed by other hosts. As a result, users or storage administrators do not need to configure the storage system to create the logical devices.

Preferably, a storage system according to a preferred embodiment includes a set of information storage media, typically hard disk drives, for storing data in response to instructions provided to the storage system and a storage controller coupled to the hard disk drives. The storage controller includes a logical device manager for defining a group of logical devices from among the hard disk drives. Each logical device (LDEV) is assigned a storage area that includes at least a portion from one hard disk drive, and the logical device manager maintains a record of the relationship between the logical devices and the physical hard disk drives, for example using a logical device configuration table to record such relationships.

The system also includes a virtual device manager for defining a virtual devices from the group of logical devices. Each virtual device (VDEV) includes at least a portion from one of the logical devices, and the virtual device manager maintains a record of the relationships among the logical devices and the virtual devices, for example, by using a virtual device configuration table. When a request for a data operation is received by the storage system from a host which has not previously accessed the storage system, the virtual device manager defines at least one virtual device for access by that host and registers that virtual device in the virtual device configuration table, and also assigns at least one a logical unit to the virtual device.

### BRIEF DESCRIPTION OF THE DRAWINGS

FIG. 1 is a block diagram illustrating the preferred information system implementing this invention.

FIG. 2 is a conceptual diagram illustrating logical devices;

FIG. 3 illustrates a RAID configuration table;

FIG. 4 illustrates a sample configuration of a virtual device;

FIG. 5 illustrates a virtual device configuration table;

FIG. 6 is an example of a free (unused) logical device list;

FIG. 7 illustrates a logical unit mapping table;

FIG. 8 is a flowchart illustrating a login procedure;

FIG. 9 is a flowchart illustrating a write request;

FIG. 10 is a flowchart illustrating a read request;

FIG. 11 is a flowchart illustrating operations when use of virtual devices ceases;

FIG. 12 illustrates the miscellaneous configuration table;

FIG. 13 is a block diagram of another embodiment of an information system;

FIG. 14 is a block diagram of a storage area network controller;

FIG. 15 illustrates a logical device configuration table for the implementation of FIG. 13;

FIG. 16 illustrates an access control table for the implementation of FIG. 13;

FIG. 17 is a flowchart illustrating logical device manager operations;

FIG. 18 is a flowchart of additional steps executed by a logical device manager;

FIG. 19 is a flowchart illustrating data migration;

FIG. 20 is a flowchart illustrating a write operation during migration;

FIG. 21 illustrates a read operation during migration;

FIG. 22 is a diagram illustrating an arrangement of host computers and logical units.

### DETAILED DESCRIPTION OF THE INVENTION

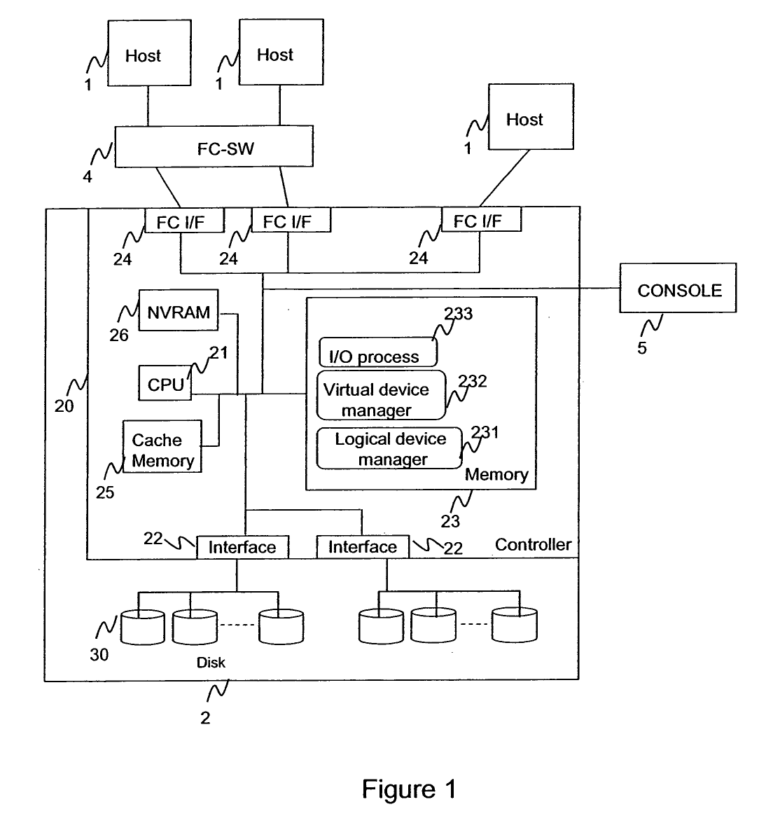

FIG. 1 is a block diagram illustrating the configuration of a typical information processing system to which this invention has been applied. As shown in FIG. 1, the system includes host computers 1, each of which is typically a conventionally available computer system, for example, as provided by numerous vendors throughout the world. Such computer systems include central processing units, memory, host bus adapters to communicate with external equipment, network interfaces, and the like. In the depicted embodiment, the hosts 1 are connected through a Fibre Channel switch 4 or directly to a storage system 2. As indicated by FIG. 1, the Fibre Channel switch 4 is not necessary for provision of such a connection, but such Fibre Channel switches are often used to enable complex interconnections among multiple hosts and multiple storage systems as discussed later below.

The storage system 2 depicted in FIG. 1 includes a variety of components, many of which are well known. Most importantly for this discussion, the storage system typically includes a disk controller 20 coupled to a desired array of hard disk drives 30. The controller and disk drives are frequently configured to implement various “Redundant Arrays of Inexpensive Disks” (RAID) configurations for providing high reliability data storage. Disks 30 typically are provided as small computer system interface (SCSI) hard disk drives, or other configuration hard disk drives, such as commercially available throughout the world.

The disk controller 20 includes a variety of components as depicted in FIG. 1. Controller 20 typically includes a CPU 21, interfaces 22 to the hard disk drives, a cache memory for temporarily storing data to be written to the disks 30. Disk controller 20 also typically includes nonvolatile memory, for example battery backed-up random access memory, designated in the figure as nonvolatile random access memory (NVRAM) 26. The disk controller interfaces with the various hosts and Fibre Channel switches using the Fibre Channel interfaces 24. Of course, if data is provided to storage system 2 in other formats, then interfaces 24 can be provided in such formats to enable data from the host to be ultimately stored in the hard disks 30. An example of another data communications format for such storage systems is Ethernet, or so-called Internet protocol storage area networks. A management console 5 is also typically connected to disk controller 20 to enable the configuration of the controller and associated hard disks. Memory 23 typically provides storage for input/output process 233, virtual device manager 232, and logical device manager 231.

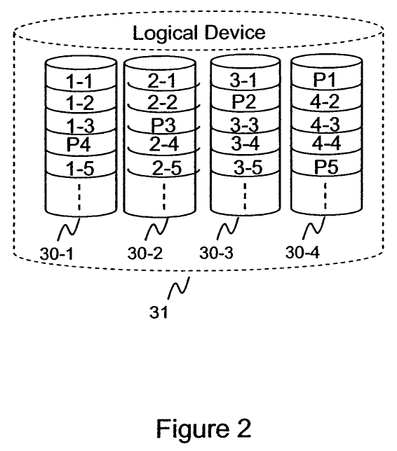

The disk controller 20 is configured to view the hard disks 30 from different perspectives. In particular, the storage controller 20 recognizes the disk array as being made up of virtual devices, logical devices, and physical devices. A physical device is a single hard disk drive, such as one designated by reference numeral 30 in FIG. 1. A logical device is typically configured by the disk controller as consisting of a plurality of physical devices or portions of the plurality of physical devices. A typical implementation of logical devices is shown in FIG. 2. As shown there, a single logical device 31 consists of four physical devices 30-1, 30-2, 30-3, and 30-4. Each particular physical device, for example 30-1, itself includes what is usually referred to as a stripe. A stripe is a predetermined length or disk block region in a RAID configuration table. For example, in FIG. 2, disk unit 30-1 includes stripes 1-1, 1-2, 1-3, and 1-5. One portion of the physical disk 30-1 is used, in typical RAID implementations, to provide parity data for error detection and correction. This parity data is stored in stripe P4.

In addition to the physical and logical devices discussed above, the disk controller can also view the data associated with it as being stored in virtual devices. A virtual device includes at least a portion of one logical device. From the perspective of the host computers 1, such computers only “see” the virtual devices and issue input/output requests using logical block addresses (LBAs) based upon such virtual devices. Disk controller 20 then translates such requests to LBAs in the logical devices to access the logical devices, and in turn, the physical disk drives themselves.

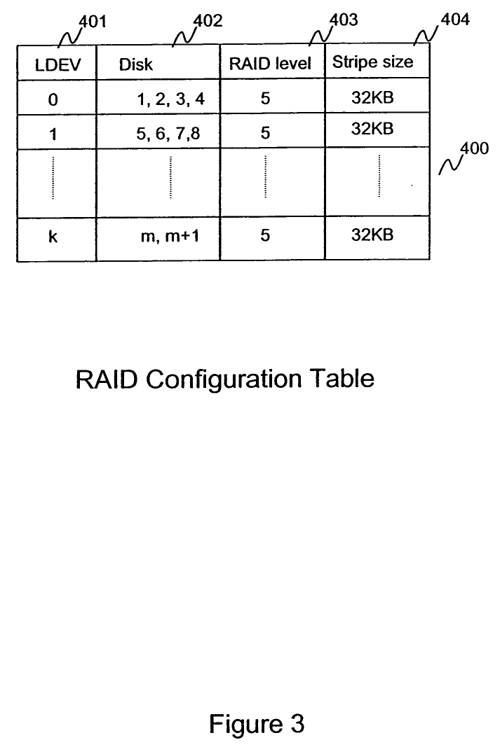

At least three types of software reside within the memory of the disk controller 20. The logical device manager 231 is the software associated with creation of logical devices from among the physical disks 30. This software enables management of the mapping, or relationships, between the logical devices and the physical disks 30. FIG. 3 provides an example of this mapping in its depiction of a RAID configuration table 400. This table is managed by the logical device manager 231. In FIG. 3 each row of table 400 contains information about each logical device. As shown, each logical device includes its own unique number, referred to the table as the logical device (LDEV) number. The table also includes a column 402. This column contains the disk numbers that together provide that logical device. Each disk is given a unique number. For example, in table 400, logical device 1 is made up by physical disks 5, 6, 7, and 8. The table also includes an indication of the RAID level 403. The RAID level consists of a digit identifying which RAID protocol is observed by that disk, typically a number between 0 and 6. The table also includes a column 404 to indicate the stripe size. In a preferred embodiment the RAID level, the number of disks constituting a RAID group, and the stripe size are all of predetermined fixed values. Before using the storage system, the user or a service technician can set these values. After the values are set, the RAID groups and logical device numbers are generated automatically when users install additional disks. In other embodiments, the users can set and change each value and each RAID level, the number of disks in each RAID group, and the stripe size.

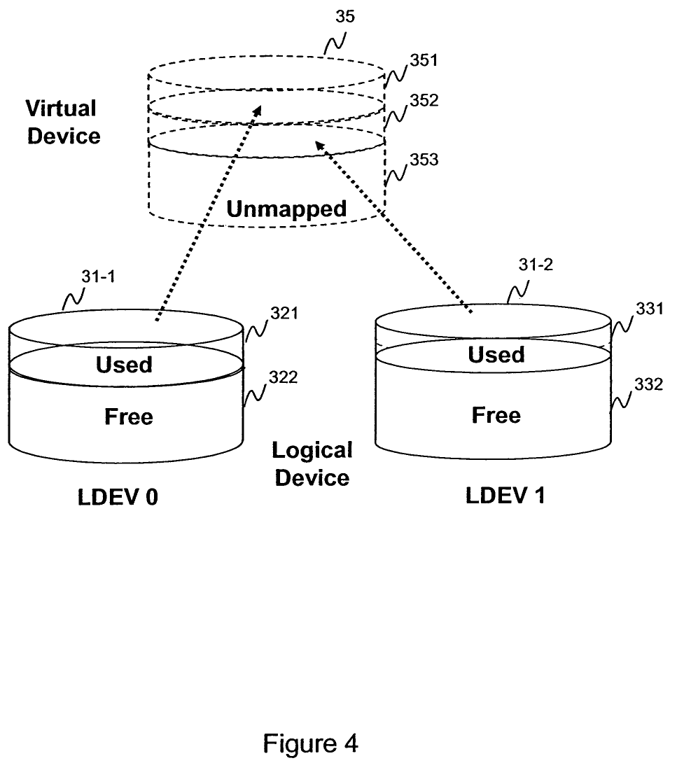

The memory 23 in the storage system 2 also contains the virtual device manager 232. The virtual device manager 232 creates virtual devices from the logical devices and manages the mapping (association) between the regions in the logical devices and the regions in the virtual devices. A typical example is illustrated in FIG. 4. As shown in FIG. 4, each region in the virtual device is mapped to a region in a logical device. More than one logical device can be mapped to each virtual device. For example, region 351 in the virtual device 35 is illustrated as being mapped to region 321 in the logical device designated “LDEV 0.” Similarly, region 352 in the virtual device 35 is mapped to region 331 in the logical device “LDEV 1.” When the virtual device is created, before any I/O operations occur, there are no regions in the virtual device mapped to regions in the logical device. When the host, however, issues an I/O request to a region in the virtual device, then, as will be discussed in more detail below, the virtual device manager 232 assigns a free region from one of the logical devices to be the corresponding region in the virtual device to which the I/O request is addressed.

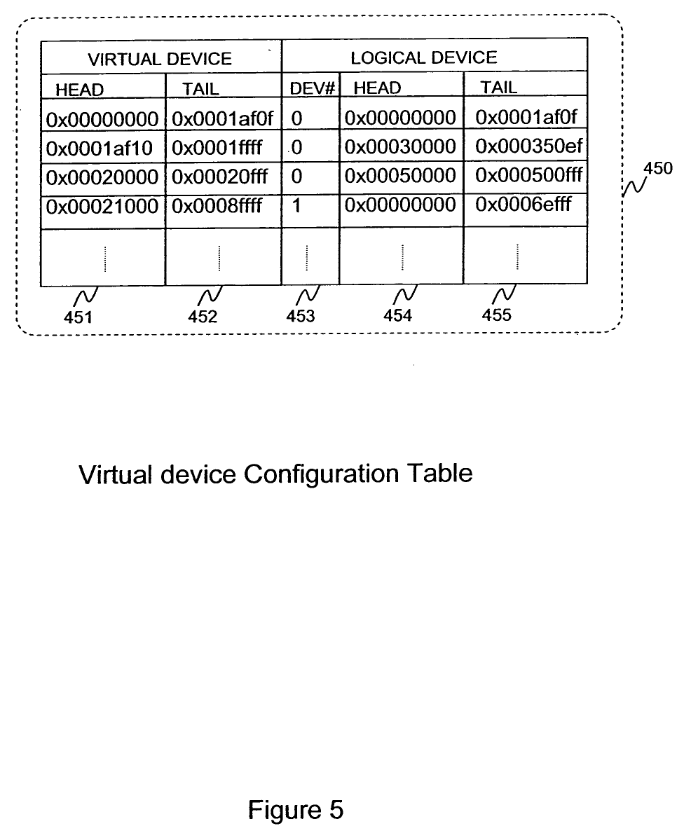

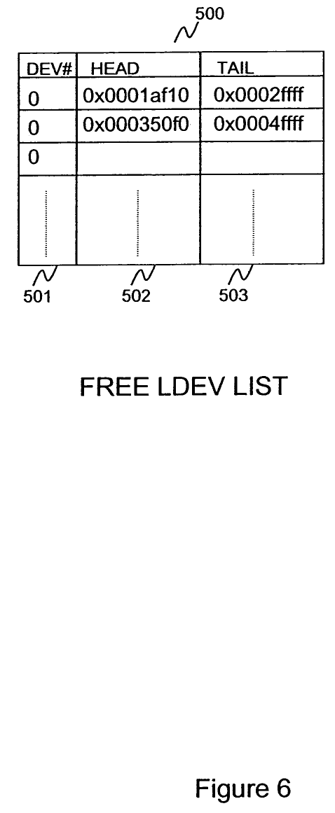

FIG. 5 illustrates the virtual device configuration table 450 in a preferred embodiment. This table 450 exists in each virtual device. Each row includes the head LBA 451, and the tail LBA 452 for the beginning and end of each region in the virtual device, the logical device number 453 and the corresponding head LBA 454 and tail LBA 455 for the data in the logical device. The table 450 manages the mapping between the virtual device and the logical devices. Each row defines the regions in the mapping of the virtual device mapped to the regions in the logical device specified by the corresponding information. The head and tail LBA (451 and 452) provide the logical block address for that data. To assign the regions of the logical device to the corresponding region in the virtual device, the virtual device manager, in response to a request from the host, maps the requested region to the logical device portion which is not already mapped. FIG. 6 illustrates the free logical device list 500. In FIG. 6 column 501 provides the logical device number, while columns 502 and 503 indicate the region of that logical device not then assigned to any virtual device.

In the Fibre Channel protocol, before the host 1 begins communicating with the storage system 2, a login procedure known as PLOGI is performed. The requester, typically the host, sends the PLOGI frame to the receiver, and the storage system, typically the receiver acknowledges receipt. This establishes communication between the two. The PLOGI frame includes the world wide name (WWN) of the host and its source identification (S_ID). After the login procedure, input/output operations are performed using commands in accordance with the small computer systems interface (SCSI) protocol, or the FCP-SCSI protocol. Typical commands include Write, Read, Inquiry, etc. U.S. Pat. No. 6,779,083 provides a detailed description of this communication process.

When the host issues an I/O request to the virtual device, each I/O request contains identification information specifying the virtual device. If this data transmission is in accordance with the Fibre Channel protocol, two kinds of identification numbers are included in the command—a destination identification (D_ID) and the logical unit number. The destination identification is a parameter specifying one of the target interfaces 24 (see FIG. 1). This parameter will typically be determined by the Fibre Channel switch if it is present when the switch login (fabric login—FLOGI) operation is performed between the storage system and the switch. Then the logical unit number (LUN) is used to specify one of the devices that can be accessed from that target interface 24 as specified by the destination ID. Because in the embodiment being described, every virtual device can be accessed from any interface 24, the logical unit numbers must be assigned to each of one of the virtual devices.

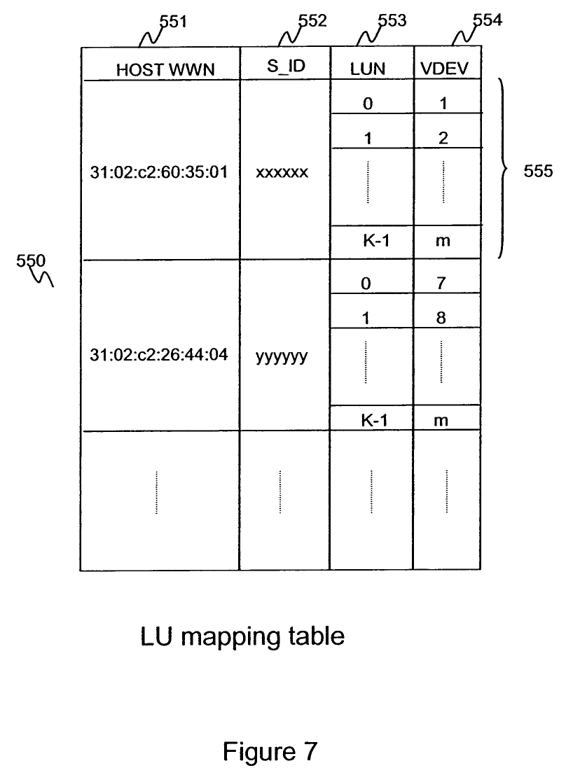

Next the manner in which a host accesses a virtual device is described. When the host computer 1 is connected to the storage system 2, the PLOGI process is executed. As described above, this provides the world wide name and source identification of the host, and registers those in an LU mapping table 550, for example as shown in FIG. 7. As shown there, column 551 contains the host world wide name, column 552 the source identification, column 553 the logical unit number, and column 554 the virtual device number. The devices defined at this point can be accessed only by the host indicated in the table. After the PLOGI process is performed, then the host can access the virtual devices by issuing SCSI commands containing the assigned logical unit numbers. Although the destination identification in one of the interfaces 24 is also included in the access commands, the storage system does not use the destination identification to specify the virtual device. Instead, the storage system uses the source ID and the logical unit number to identify the virtual device in response to SCSI commands coming from the host. The LU mapping table 550 depicted in FIG. 7 maintains the combination of these various parameters, enabling unique identifications for each.

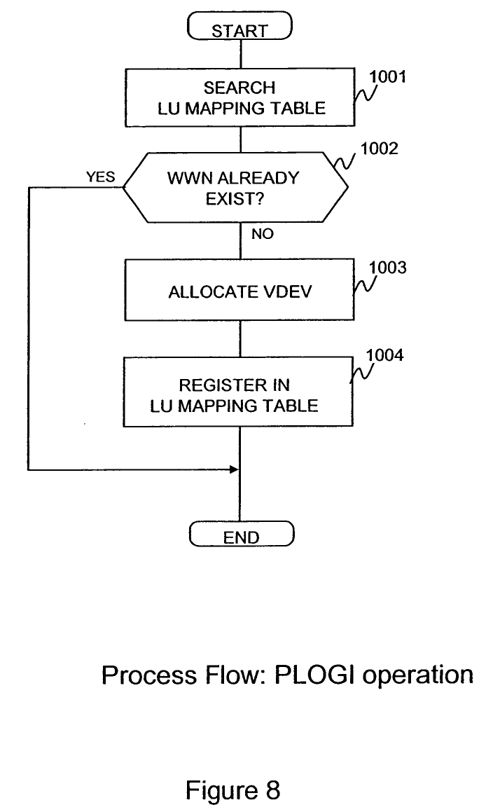

FIG. 8 is a flowchart illustrating the process flow in response to a PLOGI request coming from host 1 to storage system 2. This process is executed by the I/O process 233 in memory 23 (see FIG. 1). The virtual device manager 232 may also be invoked by the process. As shown in FIG. 8, the process starts in response to a PLOGI request from the host to the storage system. At step 1001 the LU mapping table 550 is searched to determine if the WWN associated with the request already exists in the LU mapping table 550. As shown at step 1002, if the WWN exists, the process is ended. If not, the process proceeds on to step 1003. At this step, the virtual device manager 232 defines a predetermined number of virtual devices and assigns an LUN to each virtual device. The number of virtual devices that are to be defined is a fixed value determined upon setup of the system. Alternatively, the number can be predetermined by a user of the system in a manner described below. Finally, at step 1004 the virtual device manager 232 registers the combination of the WWN, S_ID, LUN, and the virtual device into the LU mapping table 550. In this manner, the table is populated as a result of requests from the host to the storage system.

After processing the PLOGI operation the host will “see” a number of virtual devices that are defined, but disk blocks have not yet been assigned to each virtual device. When the host next issues the FCP-SCSI command, for example Read or Write, the disk block will be assigned to the region where the read/write access is requested by the command.

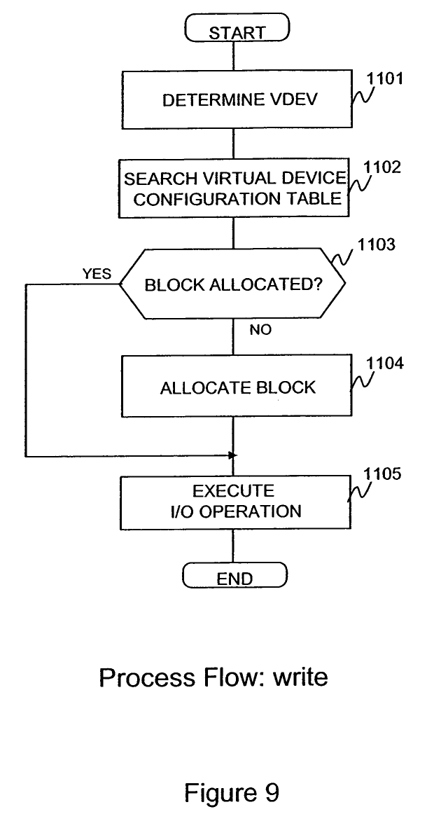

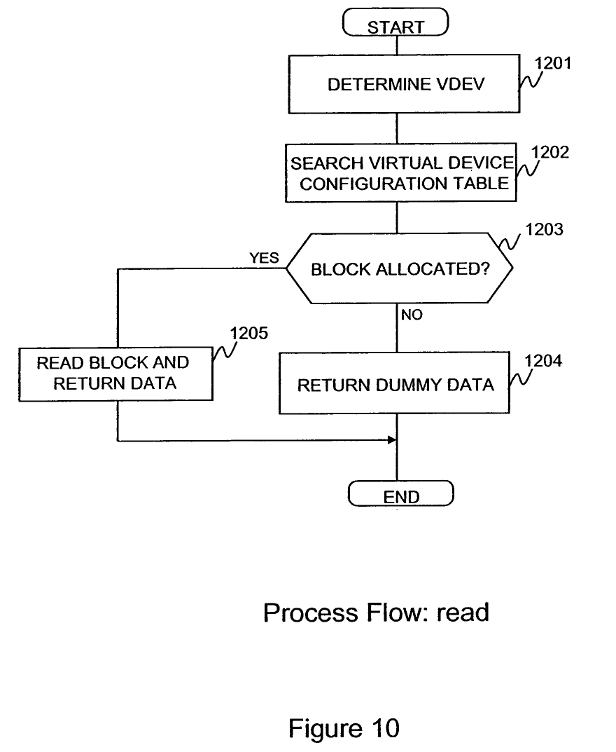

FIG. 9 shows the process flow of a write request, while FIG. 10 shows the process flow for a read request. With respect to FIG. 9, the I/O process 233 performs step 1101, with the remaining steps being performed by the virtual device manager 232. At step 1101 the storage system receives the WRITE request from the host. Because the FCP-SCSI command contains the source id of the host and the LUN to which the host requests access, the I/O process 233 can determine which virtual device the disk controller 20 is attempting to access by searching the LU mapping table 550. It then instructs the virtual device manager 232 to process the write operation.

Next at step 1102, based on the virtual device number determined at step 1101 and the logical block address (LBA) contained in the write command, the device manager 232 will search the corresponding virtual device configuration table 450 (see FIG. 5) to determine if the block in the logical device is allocated. At step 1103, if the block is allocated, the process skips to step 1105. If the block is not allocated, then the process proceeds to step 1104. At step 1104 the process allocates free block(s) from the free LDEV list 500 and then updates the virtual configuration table 450 and updates the free LDEV list 500 (see FIG. 6). Finally, at step 1105 the process executes the write operation to the allocated blocks.

FIG. 10 illustrates the process flow for a read operation. As shown there, at step 1201 the same operation is performed as at step 1101. The I/O processor 233 determines toward which VDEV the read request is issued, and then instructs the virtual device manager 232 to process the read operation. Following this, at step 1202, the virtual device configuration table 450 is searched in a manner similar to at step 1102. In this manner a determination is made as to whether the logical device has been allocated to designated LBAs. At step 1203 a determination is made as to whether the block has been allocated. If the block is allocated, then the block is read and the data returned to the host, as shown by step 1205. If, on the other hand, the block has not been allocated, then the process returns dummy data blocks, for example blocks containing all zeros, to the host.

The particular steps described in FIGS. 9 and 10 are not necessarily required to be performed in the preferred embodiment. For example, in another embodiment, when the PLOGI process described in FIG. 8 is executed, disk blocks can be allocated for every logical block address in every virtual device. While this may require additional time during setup, it eliminates the need to perform the steps in FIGS. 9 and 10 during routine operations.

One benefit of the invention is that if the host is disconnected from the storage system, either physically or logically, and then later reconnected, the host can access the same virtual devices that were defined before the disconnection. This occurs even if the host is reconnected to a different interface 24 after being disconnected.

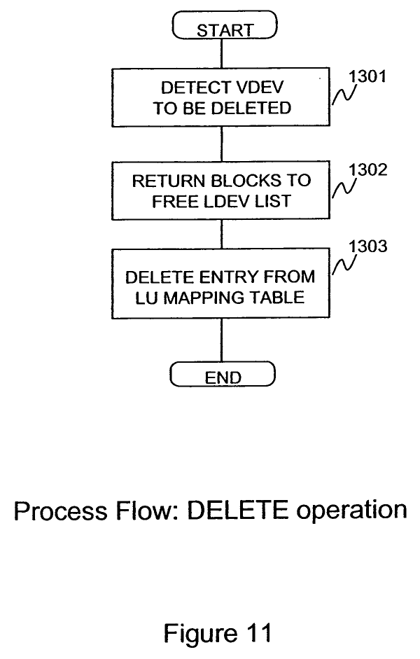

FIG. 11 is a flowchart illustrating volume deletion. When users of the storage system do not need to use a particular virtual device, they can instruct the storage system to stop using the virtual device. This is typically done using the console 5 (see FIG. 1). Upon receipt of an instruction from the console 5, the first step 1301 is to search the LU mapping table 550 to find the virtual devices to be deleted. For example, in FIG. 7 if the WWN in the first row is to be deleted, the process will determine that the virtual devices in the first row 555 are to be deleted.

Next, in step 1302 the virtual device configuration tables 450 are searched for those devices corresponding to the devices detected at step 1301. These disk blocks can then be returned to the free LDEV list 500. After returning the disk blocks to this list 500, the virtual device configuration table 450 is appropriately modified. Finally, at step 1303 the process deletes the entry of that WWN from the mapping table 550.

In the implementations discussed thus far, the virtual devices that have been defined for a host are not usable by other hosts. In some circumstances, however, users of a storage system may want to share devices among multiple hosts. To enable this, the storage system can define virtual devices enabled to be shared by hosts. These defined devices are termed “shared LU,” as discussed next.

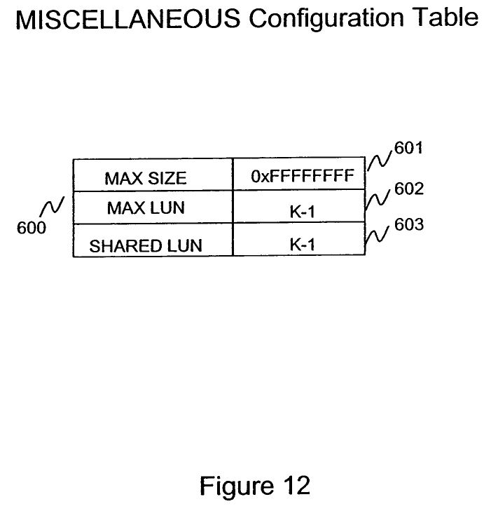

FIG. 12 illustrates a miscellaneous configuration table 600 which is maintained in the storage system. When a user specifies a particular logical unit number in row 603 (K-1 in this example), the virtual device having K-1 as its LUN can be shared by other hosts. In this case if the PLOGI process of FIG. 8 is executed when the host is connected to the storage system, the shared LU that is currently used by other hosts is assigned to the shared LU for this host. If no hosts have been connected, the virtual device allocation to the shared LU is performed in the same process as for other virtual devices, as discussed above.

In addition, for this embodiment, the size of the virtual device, the number of virtual devices that are assigned to each host, or the LUN of the shared virtual device are all defined by the storage system. In another embodiment, these factors can be changed by the user of the storage system, for example, by using console 5 to specify a maximum size and maximum LUN in table 600.

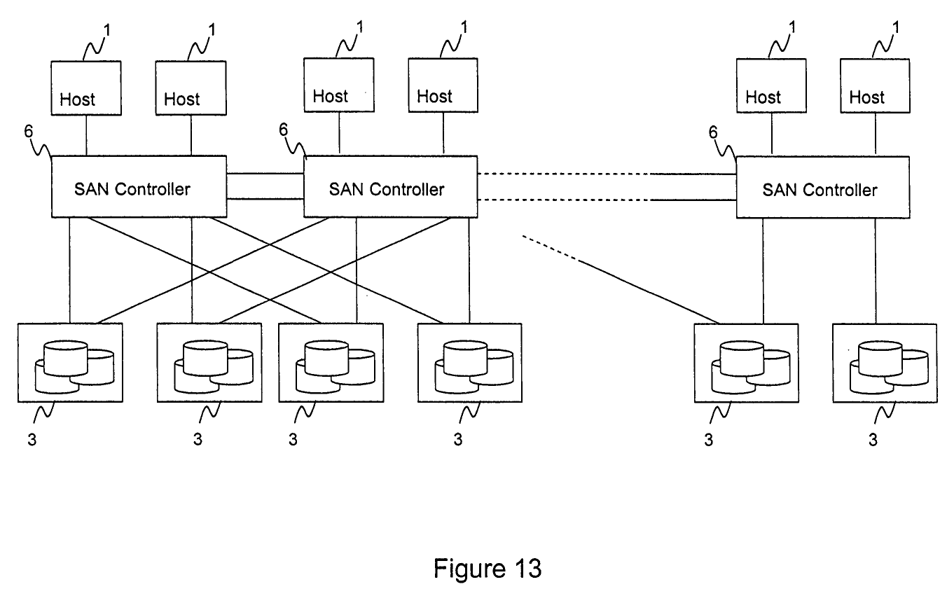

FIG. 13 is a block diagram illustrating another configuration of a storage system. As shown in FIG. 13, a series of host computers 1 are connected through a group of SAN controllers 6 to a set of storage systems 3. In this embodiment storage systems 3 are typical systems, for example disk arrays having RAID capability, or “just a bunch of disks” (JBOD). In the depicted embodiment, the SAN controllers 6 interconnect the hosts with the storage systems, for example using Fibre Channel, Ethernet, or other appropriate protocols.

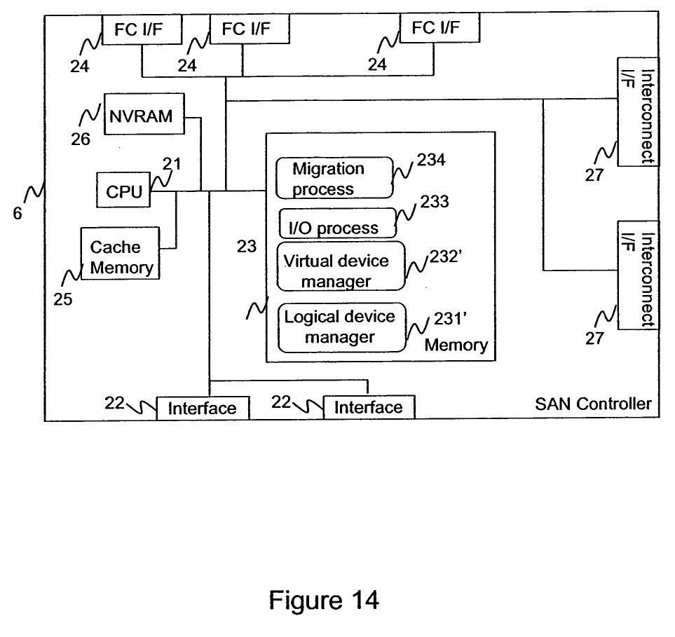

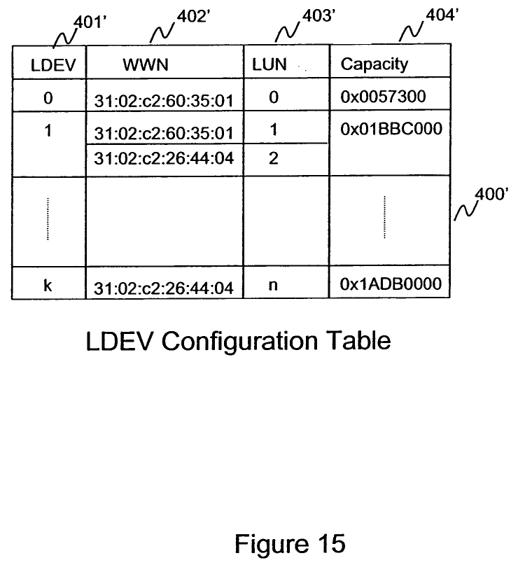

SAN controller 6, shown in more detail in FIG. 14, provides functionality similar to the disk controller 20 discussed in conjunction with FIG. 1. In FIG. 14, components of the SAN controller that correspond to components of the storage controller 2 in FIG. 1 have been given the same reference numbers. The interconnect interfaces 27 are used for communicating with the other SAN controllers 6. The processes that operate in SAN controller 6 are similar to the processes in disk controller 20 in the first embodiment. One difference, however, is that in the SAN controller 6, the logical device manager 231′ itself does not create RAID disk groups, although each individual storage system may create RAID disk groups within that storage system. In addition, the SAN controllers 6 function in a manner similar to the host computers previously discussed. The controller 6 will issue I/O requests to each of the devices and each of the storage systems 3 by designating a destination identification, and will use the LDEV configuration table 400′ (see FIG. 15) to manage all the logical devices of the storage systems 3. With respect to FIG. 15, the LDEV column 401′ results from the discovery of all devices in the storage system by the controller 6 and the assignment of an LDEV number to each device. The table also stores the WWN 402′ and the LUN 403′, as well as the capacity of each device. In FIG. 15 the capacity is designated as the number of disk blocks (typically 1 block equals 512 bytes) using hexadecimal notation.

As suggested by FIG. 13, in some configurations a device will be accessible from more than one access path. In such circumstances the SAN controller 6 will record a group of combinations of world wide names and logical unit numbers. For example, as shown in FIG. 15 the device whose logical device number is 1 includes two sets of data indicating such access. In a manner similar to that described above, the disk discovery process can be done periodically, during initial setup, or performed when users instruct the controller 6 to discover devices. After the discovery process is completed, each controller 6 provides information about the discovered devices to all of the other controllers 6. Thus, all controllers 6 will have the same LDEV configuration table 400′. If additional controllers are added, then the information can be copied to those additional controllers 6.

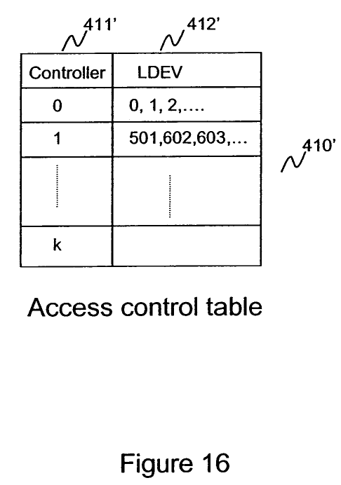

FIG. 16 depicts an access control table. Depending upon the particular configuration, some devices may not always be connected to every controller 6 directly. As a result, each SAN controller 6 manages the mapping information for devices connected to the other SAN controllers. This information is referred to here as an access control table 410′ and is shown in FIG. 16. The table includes a column 411′ designating the identification number of the SAN controller, and a column 412′ showing the LDEV number for the devices connected to that controller. In the terminology of systems such as depicted in FIG. 13 a logical device directly connected to a SAN controller is called a local LDEV, while a logical device connected to a remote (non-local) SAN controller is referred to as a remote LDEV.

The virtual device manager 232′ is similar to that of the first embodiment. The virtual device manager 232′ maintains the virtual device configuration table 450, the free LDEV list 500, and the LU mapping table 550. This information is shared by all of the controllers 6. When the tables are updated in one controller, one of the controllers designated to be the master controller, sends the notice to all of the other controllers so that they do not update the information while the master controller is updating the information. After the master controller completes its update of the tables, it sends notice to the other controllers that the update operation has been completed, thereby enabling all of the controllers to maintain the same information.

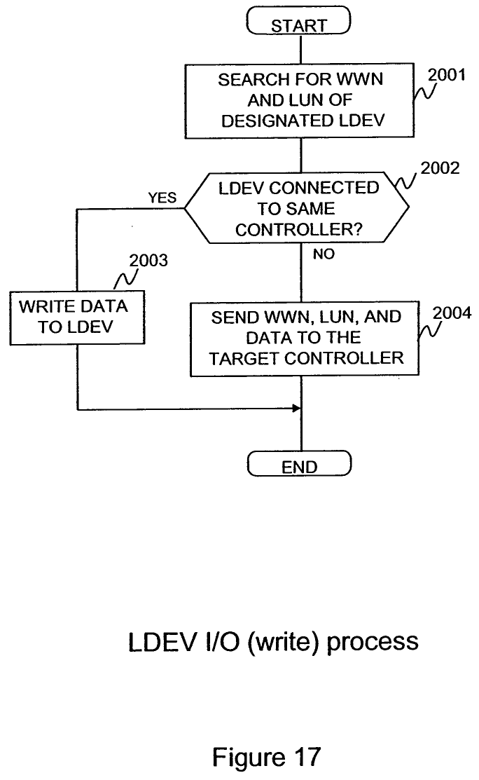

In general, the operations of the system depicted in FIG. 13 are the same as those as depicted in FIG. 1, with a few exceptions. FIG. 17 shows the detailed process flow of step 1105 which is executed by the logical device manager 231′. Step 1105 is shown in FIG. 9 with respect to the implementation shown in FIG. 1. The process steps of FIG. 17 are carried out in the same SAN controller 6 as the one which receives the I/O request from the host. At step 2001 the logical device manager 231′ searches the LDEV configuration 400′ to find the WWN 402′ and the LUN 403′ which are assigned to the LDEV designated by the virtual device manager 232′. At step 2002 the logical device manager 231′ searches the access control table 410′ to determine if the LDEV that is designated by the virtual device manager 232′ is connected to the same SAN controller 6 which is processing the current request. (In other words, it checks to see if the LDEV is a local LDEV). If the LDEV is connected to the same controller 6, the process proceeds to step 2003 and the data is written. If the LDEV is not a local LDEV, then as shown by step 2004, the logical device manager 231′ sends the write request to the appropriate location where the LDEV is connected. The write request is accompanied by the WWN 402 and the LUN 403.

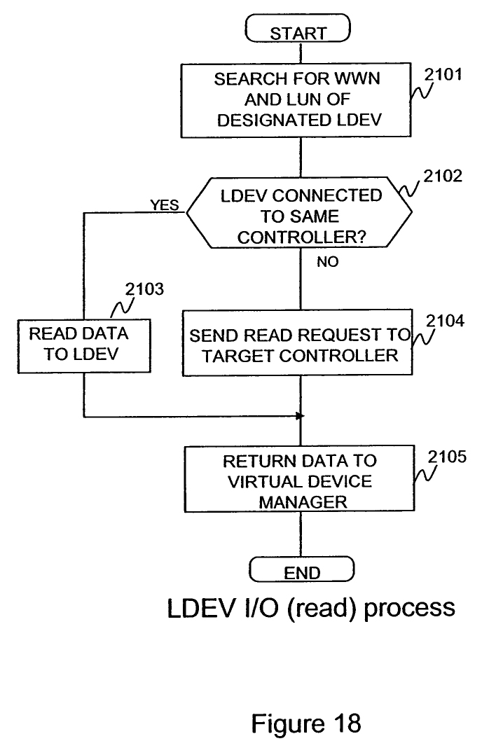

Another operation where changes are necessary with respect to the implementation of FIG. 13 in contrast to the implementation of FIG. 1 is with respect to step 1205 in FIG. 10. FIG. 18 illustrates the process flow to carry out this step. This process is performed in the logical device manager 231′ that resides in the same controller 6 as the one that receives the I/O request from the host. At step 2101 the same operation is performed as in step 2001 of FIG. 17. At step 2102 the determination is made as to whether the LDEV is connected to the same controller, and if so, the data is read and returned to the logical device manager 231′ and then to the virtual device 232′.

If, instead a determination is made at step 2102 that the LDEV is not connected to the same controller, then as shown by step 2104 the read request is sent to the target controller for the appropriate LDEV. As with the write request, the read request is accompanied with the WWN 402′ and the LUN 403′. Finally, at step 2105 data is returned to the virtual device manager.

For the implementation of FIG. 13, there is a potential performance degradation. This can occur if too many requests to the controllers 6 are required to be redirected to appropriate controllers based upon the locations of the various LDEVs. One technique for minimizing this potential problem is to base the choice of free blocks in LDEVs upon the locations where the I/O requests are received. This can be achieved by having the virtual device manager 232′ choose a free block in an LDEV which is connected to the SAN controller 6 which receives the request. If there are no free blocks, then an LDEV associated with a different controller 6 can be selected instead.

FIG. 14 also includes a migration process 234. If the LDEV allocation approach described above is used, overhead can be reduced. If, however, the host is connected to another controller 6, for example when the network is reconfigured, it may be desirable to migrate data to the other LDEVs connected to the new controller associated with a particular host. In this circumstance, a data migration operation is performed by the migration process 234.

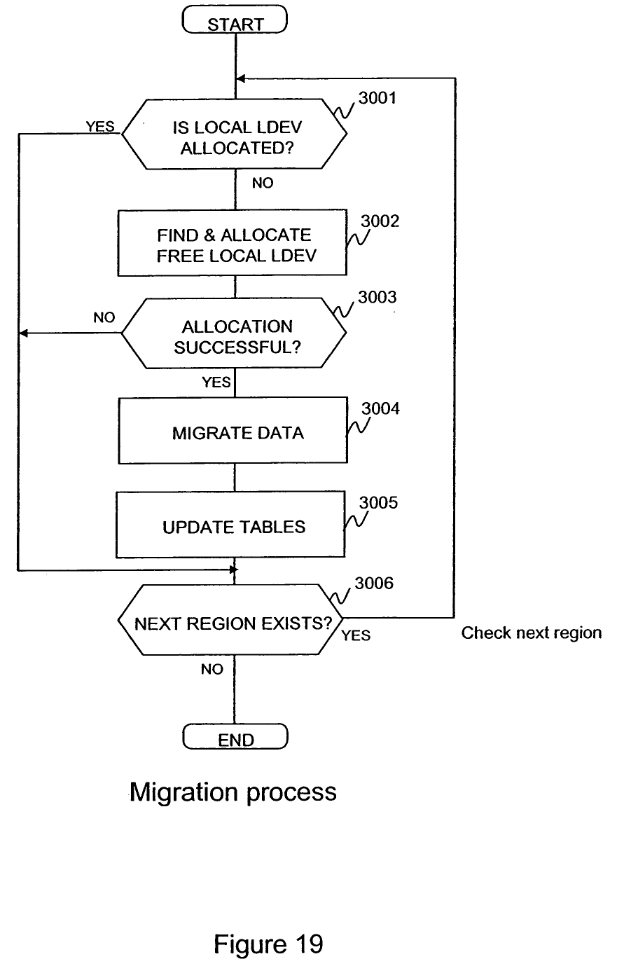

FIG. 19 is a flowchart illustrating such a data migration process. As mentioned above, this process can be invoked when the network is reconfigured, or invoked if one of the controllers 6 detects an excessive amount of communication among all of the different controllers 6. The process of FIG. 19 searches each row of the virtual device configuration table 450 from the first row to the last row to locate those regions to be migrated. The process begins with step 3001 in which a determination is made if the region of the selected row (i.e. the row then being considered for migration) to be migrated is in a local LDEV. If it is, the process skips to step 3006. If the selected row is not in the local LDEV, the process proceeds to step 3002. During that operation the process searches the free LDEV list 500 to find a free region in the local LDEV whose size is large enough to accommodate the selected region, and that region is attempted to be allocated. As shown by step 3003 if the allocation is successful, the process proceeds to step 3004 to migrate the data. If the allocation is not successful the process moves to step 3006 where the configuration tables are updated (as discussed below).

Next, at step 3004 the data is copied from the current region to the allocated region, typically in the local LDEV. At step 3005 the free LDEV list 500 and the virtual device configuration table 450 are updated to reflect the changes just made. At step 3006 the process is checked to see if the next row exists in the virtual device configuration table 450, and if it does, the process returns to step 3001. If it does not, then all of the data has been migrated and the process ends.

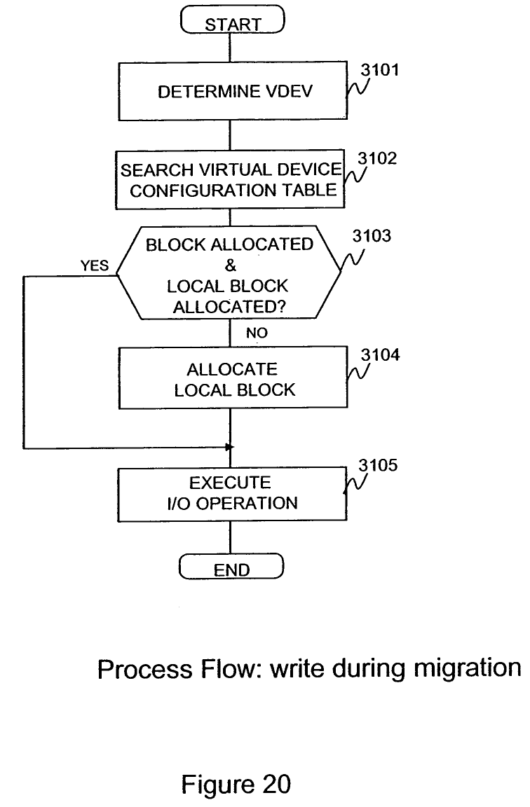

FIG. 20 is a flowchart illustrating the write operation during the migration process. Step 3101 is the same as step 1101 during which the process determines which VDEV the controller 6 is accessing by searching the LU mapping table 550. At step 3102 the same operations are performed as during step 1102. Based on the VDEV determined at step 3101 and the logical block address contained in the write command, the process will search the corresponding virtual device configuration table 450. At step 3103 the determination is made as to whether the blocks are allocated in the designated LBA of the virtual device and if they are in the local LDEV. If so, the I/O operation is executed as shown by 3105. If not, the process proceeds to step 3104. There, a free block is allocated based upon the free LDEV list 500. If the blocks that are not in the local LDEV are allocated, the process returns these blocks to the free list 500 and reallocates the free blocks that are in the local LDEV from the free LDEV list 500. After the allocation the virtual device configuration table 450 and the free LDEV list 500 are updated. If they have not sufficient space in the local LDEV, then the process proceeds to step 3105 without any allocation.

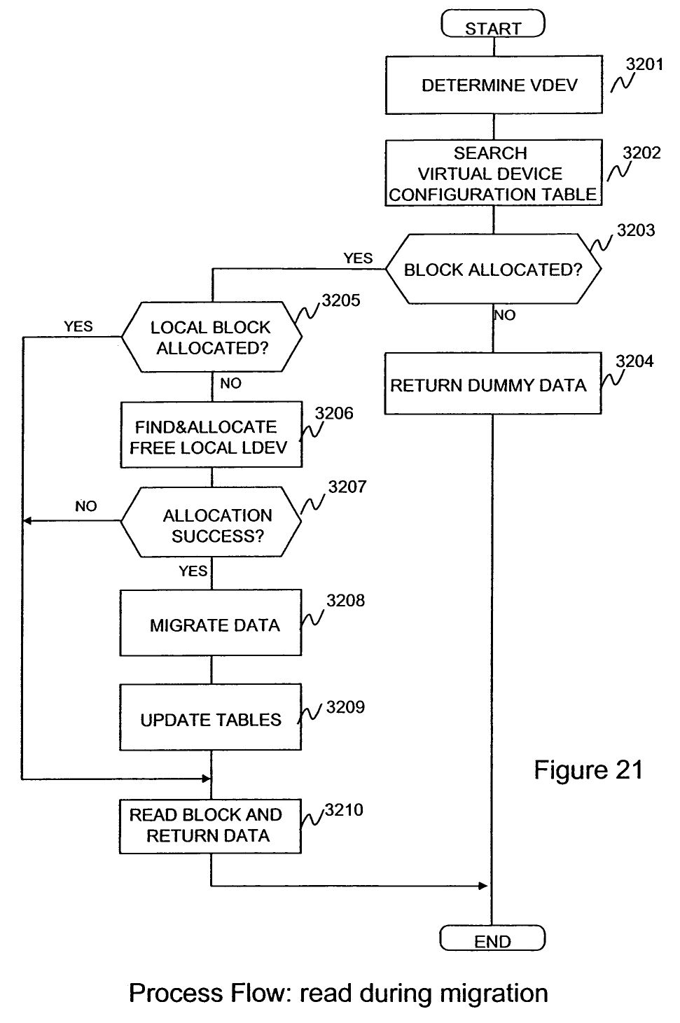

FIG. 21 is a diagram illustrating the operations which occur if a read operation is performed during migration. The steps in FIG. 21 are similar to those in FIG. 10, with step 3201 corresponding to step 1201, step 3202 corresponding to step 1202, and step 3203 corresponding to step 1203. If blocks are allocated in the designated LBA of the virtual device, the process goes to step 3205, and if the blocks are not allocated the process proceeds to step 3204 (return dummy data). At step 3205 the process determines if the local blocks are allocated to the region designated by the read request. If they are, the data is read and returned as shown by step 3210. If not, the process moves to step 3206 which corresponds to step 3002 in FIG. 19. Next in step 3207 a similar operation is performed as that in step 3003. A determination is made if the allocation succeeded. If it did, the process moves to step 3208 and the data has migrated, then the tables are updated. Step 3208 corresponds to step 3004, step 3209 to step 3005, and step 3210 to step 1205.

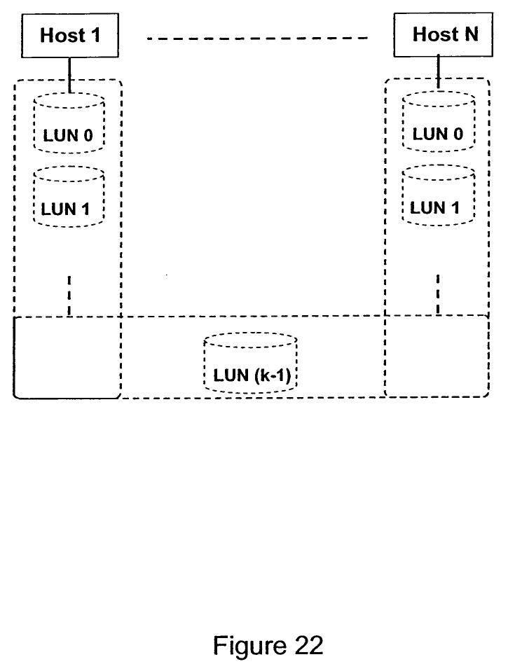

From the perspective of the host computers, regardless of the physical configuration of the storage system, i.e. the number of other hosts and other storage systems, each host sees the logical units which are not shared with other hosts unless logical devices have been defined as shared, for example, as shown in FIG. 22. The logical view will remain the same regardless of the number of hosts or disk devices added or deleted, or the changes in network topology. Users are able to access the logical devices as soon as they connect the particular host to the storage system or the storage network, and changes in the settings of the storage system or the storage network are not necessary.

The preceding has been a description of the preferred embodiments. The scope of the invention is set forth by the appended claims.

What is claimed is:

1. A storage system comprising:
a plurality of information storage media for storing data in response to instructions provided to the storage system;
a storage controller coupled to the plurality of information storage media, the storage controller including:
a logical device manager for defining a plurality of logical devices from the plurality of information storage media, each logical device including at least a portion of one of the plurality of information storage media, the logical device manager maintaining the relationships among the logical devices and the information storage media by using a logical device configuration table to thereby define such relationships; and
a virtual device manager for defining a plurality of virtual devices from the plurality of logical devices, each virtual device including at least one portion of at least one logical device, the virtual device manager maintaining the relationships among the logical devices and the virtual devices by using a virtual device configuration table to thereby define such relationships;
whereby, when a request for a data operation is received by the storage system from a host which has not previously accessed the storage system, the virtual device manager defines at least one virtual device for access by that host and registers that virtual device in the virtual device configuration table, and also assigns at least one a logical unit number to each of the at least one logical devices.

2. A storage system as in claim 1 wherein the system further includes a logical unit mapping table, and this table stores an identification of the host, the virtual devices and the corresponding logical device.

3. A storage system as in claim 1 wherein if the data operation is a write operation to an address assigned to the logical device, the write is carried out, and wherein if the address is not already assigned to the logical device, a free block is selected and assigned for the write, and the virtual device configuration table is updated.

4. A storage system as in claim 3 wherein if the data operation is a read operation and the address is already assigned to the logical device, the read is carried out, and wherein if the address is not already assigned to the logical device, dummy data is returned in response to the read.

5. A storage system as in claim 1 wherein when the request for a data operation is received by the storage system from a host which has not previously accessed the storage system, the virtual device manager defines a predetermined number of virtual devices for access by that host and registers each such virtual device in the virtual device configuration table, and also assigns a logical unit number to each such logical device.

6. A storage system as in claim 1 wherein when a request to stop using a virtual device is received by the storage system from a host, the virtual device manager removes from the virtual device configuration table the assigned logical units and returns those units to an available logical unit list, then deletes the virtual device.

7. A storage system as in claim 1 wherein if the virtual device is to be shared by a seconds host in addition to the host registered in the virtual device configuration table, the virtual device manager defines that virtual device as able to be accessed by the second host and again registers that virtual device in the virtual device configuration table with a further entry, and also assigns at least one a logical unit number to the second host.

8. A storage system as in claim 1 wherein the logical device configuration table includes a logical device number and a disk identification number assigned to such logical device number.

9. A storage system as in claim 8 wherein the logical device configuration table further includes an indication of a RAID level for such logical device, and a stripe size specification for that logical device.

10. A storage system as in claim 1 wherein the storage controller maintains a logical unit mapping table defining relationships among hosts and logical units, and using at least a world wide name, a determination is made of whether that host has accessed that storage system previously.

11. A storage system as in claim 10 wherein if the storage system has not been previously accessed by that host, then a new entry is made in the logical unit mapping table for that host.

12. A storage system comprising:
a first and a second plurality of information storage media for storing data in response to instructions provided to the storage system;
a first and a second storage area network controller, the first controller coupled to the first plurality of information storage media, and the second controller coupled to the second plurality of information storage media, each of the first and second storage area network controllers being coupled to receive data operations from hosts, each of the first and second storage area network controllers including:
a logical device manager for defining a plurality of logical devices from the plurality of information storage media, each logical device including at least a portion of one of the plurality of information storage media, the logical device manager maintaining the relationships among the logical devices and the information storage media by using a logical device configuration table to thereby define such relationships;
a virtual device manager for defining a plurality of virtual devices from the plurality of logical devices, each virtual device including at least one portion of at least one logical device, the virtual device manager maintaining the relationships among the logical devices and the virtual devices by using a virtual device configuration table to thereby define such relationships, the virtual device manager defining at least one virtual device for access by that host and registering that virtual device in the virtual device configuration table, and also assigning at least one a logical unit number to each of the at least one logical devices;
whereby, when a request for a data operation is received by the one of the first and second storage area network controllers from a host, a determination is made as to whether the logical device to which the request will be submitted is within the plurality of information storage media associated with that storage area controller, and if not, then the request is forwarded to another storage area network controller.

13. A method for assigning storage devices in a storage system for access by a host computer, the method comprising:
defining a plurality of logical devices from a plurality of information storage media, each logical device including at least a portion of one of the plurality of information storage media;
maintaining a record of relationships among the logical devices and the information storage media;
defining a plurality of virtual devices from the plurality of logical devices, each virtual device including at least one portion of at least one logical device;
maintaining a record of relationships among the virtual devices and the logical devices;
whereby, when a request for a data operation is received by the storage system from a host which has not previously accessed the storage system, at least one virtual device is defined for access by that host and at least one a logical unit number is assigned to that virtual device.

14. A method as in claim 13 wherein the step of maintaining a record of relationships among the logical devices and the information storage media includes using a logical device configuration table to thereby define such relationships.

15. A method as in claim 14 wherein the step of maintaining a record of relationships among the virtual devices includes using a virtual device configuration table to thereby define such relationships.

16. A method as in claim 15 wherein the system further includes a step of storing in a logical unit mapping table an identification of the host computer, the virtual devices accessible by that host and logical devices associated with those virtual devices.

17. A method as in claim 16 further comprising:
when a write operation to an address is performed a determination is made as to whether the address is already assigned to a logical device; and
if the address is not already assigned to a logical device, then a free block of storage is selected and assigned for storage of data, and the virtual device configuration table is updated.

18. A method as in claim 16 further comprising:
when a read operation to an address is performed a determination is made as to whether the target address is already assigned to a logical device; and
if the address is not already assigned to a logical device, then a free block of storage is selected and dummy data is returned in response to the read operation.

19. A method as in claim 13 wherein the step of when a request for a data operation is received by the storage system from a host which has not previously accessed the storage system further comprises defining a predetermined number of virtual devices for access by that host, registering each such virtual device in the virtual device configuration table, and assigning a logical unit number to each such logical device.

20. A method as in claim 15 further comprising:
in response to a request to stop using a virtual device, a step of removing from the virtual device configuration table all logical units assigned to that virtual device;
returning those logical units to an available logical unit list; and
deleting the virtual device from the virtual device configuration table.

21. A method as in claim 20 further comprising when a virtual device is to be shared by an additional host, steps of:
defining that virtual device as able to be accessed by the additional host;
registering that virtual device in the virtual device configuration table;
assigning at least one logical unit to the virtual device for the additional host.

22. A method as in claim 13 further comprising:
maintaining a logical unit mapping table defining relationships among hosts and logical units; and
using at least a world wide name, determining a determination is made of whether that host has previously accessed that storage system.

23. A method as in claim 22 further comprising if the step of determining whether that host has previously accessed that storage system results in a determination that it has not, then making a new entry in the logical unit mapping table for that host.

24. A method for assigning storage devices in a storage system having a plurality of host computers coupled via at least a plurality of storage area network controllers to a plurality of storage systems, each storage system having a plurality of storage media, which storage media may be assigned to logical units and which logical units may be assigned to virtual units, the method comprising:
defining a plurality of logical devices from the plurality of storage media, each logical device including at least one storage media;
maintaining a record of relationships among the logical devices and the storage media by using a logical device configuration table to thereby record such relationships;
defining a plurality of virtual devices from the plurality of logical devices, each virtual device including at least one portion of at least one logical device;
maintaining a record of relationships among the logical devices and the virtual devices by using a virtual device configuration table to thereby record such relationships;
defining at least one virtual device for access by a host;
registering that virtual device in the virtual device configuration table;
assigning at least one logical unit number to each of the logical devices selected in the step of defining a plurality of logical devices from the plurality of storage media; and
when a request for a data operation to a requested virtual device is received by one of the storage area network controllers from a host, determining if the logical device defined for that virtual device is connected to that storage area controller, and if not, then forwarding that request to another storage area network controller.
